(19) United States
(12) Patent Application Publication
(10) Pub. No.: US 2012/0141215 A1
(43) Pub. Date: Jun. 7, 2012

(54) Multi-Functional Cutting Tool

(75) Inventors: Chang Hee Choi, Dalsung-gun (KR); Hong Sik Park, Dalsung-gun (KR); Chul Ho Lee, Dalsung-gun (KR)

(73) Assignee: TaeguTec, Ltd., Dalsung-gun, Daegu (KR)

(21) Appl. No.: 13/389,782

(22) PCT Filed: Jan. 12, 2010
(86) PCT No.: PCT/KR2010/000193

§ 371 Date: Feb. 9, 2012

(30) Foreign Application Priority Data
Aug. 26, 2009 (KR) 10-2009-0079396

(51) Int. Cl. B23B 27/10; B23B 51/06; B23B 51/02; B23B 27/16; B23B 27/22

(52) U.S. Cl. 407/11; 408/22

(57) ABSTRACT

A multi-functional cutting tool can be used for a turning process as well as a drilling process. The multi-functional cutting tool includes: a shank having a flat surface to be fixed to a cutting device; first and second cutting portions of cylindrical shape, each of which extends from the respective ends of the shank; and a cooling hole straightly extending and penetrating into the cutting tool from the end of the first cutting portion to the end of the second cutting portion in a direction of the rotational axis of the cutting tool.

### TECHNICAL FIELD

The present invention generally relates to a cutting tool, and more particularly to a multi-functional cutting tool, which can be used for a turning process as well as a drilling process.

### BACKGROUND ART

There are typically two types of cutting process. The first type is working a work piece by contacting a cutting edge of a cutting tool having a straight movement with a rotating work piece. The second type is working a work piece by contacting a work piece having a straight movement with a rotating cutting tool. The examples of the first type are an outer diameter turning process, an inner diameter turning process, a cross-section turning process, a screw process, a drilling process, etc. The examples of the second type are a milling process and a drilling process. A drilling process can be used with both types.

A multi-functional cutting tool is a cutting tool, which can be used for a drilling process as well as a turning process. It has one cutting edge and a chip removing groove that extends therefrom.

FIG. 1 shows a conventional multi-functional cutting tool (10). As shown in FIG. 1, the multi-functional cutting tool (10) includes a cutting portion (12) having a pocket for receiving one cutting insert and a shank (14) to be fixedly mounted on the cutting tool. The multi-functional cutting tool (10) can make a drilling process while travelling in an axial direction of the cutting tool. Further, it can make a turning process while travelling in a direction perpendicular to the axial direction of the cutting tool. However, there is a drawback in that such multi-functional cutting tool (10) has only one cutting portion (12) at its one side, thereby having a shorter lifespan than a cutting tool with two cutting portions.

### DISCLOSURE OF INVENTION

### Technical Problem

In order to solve the problem as stated above, the present invention is directed to providing a multi-functional cutting tool, which includes a cutting portion at each end of a shank and provides identical cooling effect and strength to the cutting portions for extension of its lifespan.

### Technical Solution

The multi-functional cutting tool in accordance with one embodiment of the present invention includes: a shank having a flat surface to be fixed to a cutting device; first and second cutting portions of cylindrical shape, each of which extends from the respective ends of the shank; and a cooling hole straightly extending and penetrating into the cutting tool from the end of the first cutting portion to the end of the second cutting portion in a direction of the rotational axis of the cutting tool. The first cutting portion includes a first chip removing groove comprising a first plane having a first cutting edge and a second plane inclined at an angle with respect to the first plane. The second cutting portion includes a second chip removing groove comprising a third plane having a second cutting edge and being substantially on the same plane as the second plane and a fourth plane being substantially on the same plane as the first plane. The respective angles defined by the center of the cooling groove and each of the first to fourth planes are substantially identical to each other. The flat surface is arranged to be substantially perpendicular to an imaginary line bisecting the inclination angle between the first plane and the second plane in the first cutting portion.

The multi-functional cutting tool in accordance with another embodiment of the present invention includes: a shank having a flat surface to be fixed to a cutting device; first and second cutting portions of cylindrical shape, each of which extends from the respective ends of the shank; and a cooling groove formed on the flat surface of the shank and extending in a direction of the rotational axis of the cutting tool. The first cutting portion includes a first chip removing groove comprising a first plane having a first cutting edge and a second plane inclined at an angle with respect to the first plane. The second cutting portion includes a second chip removing groove comprising a third plane having a second cutting edge and being substantially on the same plane as the second plane and a fourth plane being substantially on the same plane as the first plane. The cooling groove is connected to the first chip removing groove and the second chip removing groove. The flat surface is arranged to be substantially perpendicular to an imaginary line bisecting the inclination angle of the first plane and the second plane in the first cutting portion.

### Advantageous Effects

According to the present invention, the lifespan of the multi-functional cutting tool for both drilling process and turning process is prolonged. In particular, to change a cutting portion for its use, an unused cutting portion, which was inserted into a mounting sleeve, is mounted to protrude outside of the mounting sleeve. Further, the arrangement of a cooling hole (or cooling groove) and a cutting edge is not changed. Thus, the same cooling effect can be provided to both of the cutting portions. Accordingly, both cutting edges can have the same life span. Also, since the strength of the cutting edges of the cutting portions is identical to each other, the lifespan of the multi-functional cutting tool according to the present invention can be much more prolonged than the conventional multi-functional cutting tool.

### BRIEF DESCRIPTION OF DRAWINGS

FIG. 1 is a schematic view of a conventional multi-functional cutting tool.

FIG. 2 is a schematic view of a multi-functional cutting tool in accordance with a first embodiment of the present invention.

FIG. 3 is a perspective view of the multi-functional cutting tool fixed into a mounting sleeve in accordance with the present invention.

FIG. 4 is a side view of the multi-functional cutting tool when viewed in Direction A of FIG. 2.

FIG. 5 is a side view of the multi-functional cutting tool when viewed in Direction B of FIG. 2.

FIG. 6 is a schematic view of the cutting tool comprising a cooling groove in accordance with a second embodiment of the present invention.

FIG. 7 is a side view of the multi-functional cutting tool when viewed in Direction A of FIG. 6.

FIG. 8 is a side view of the multi-functional cutting tool when viewed from Direction B of FIG. 6.

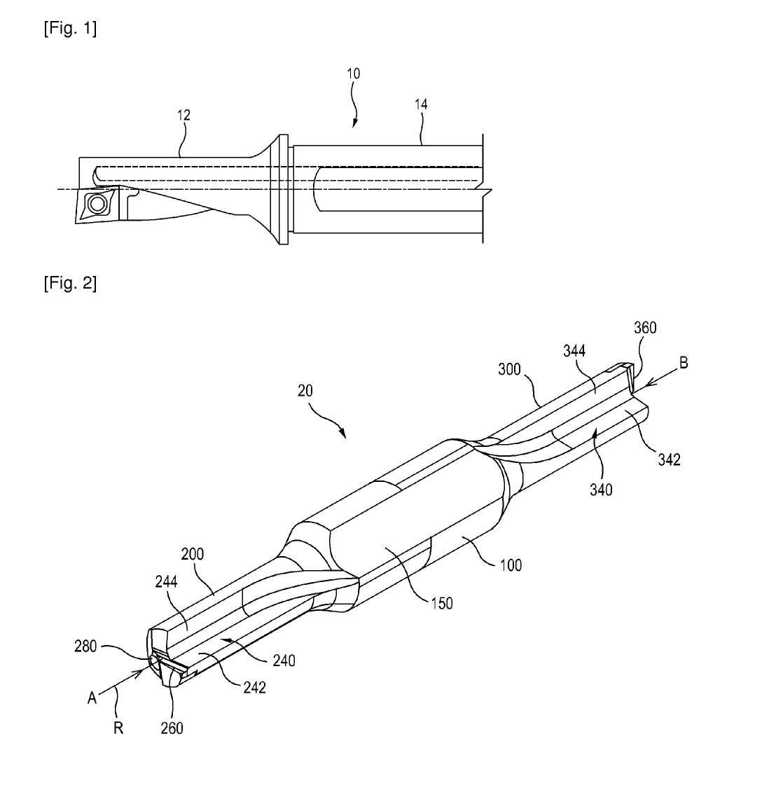

### MODE FOR THE INVENTION

The present invention will be described below with reference to the drawings.

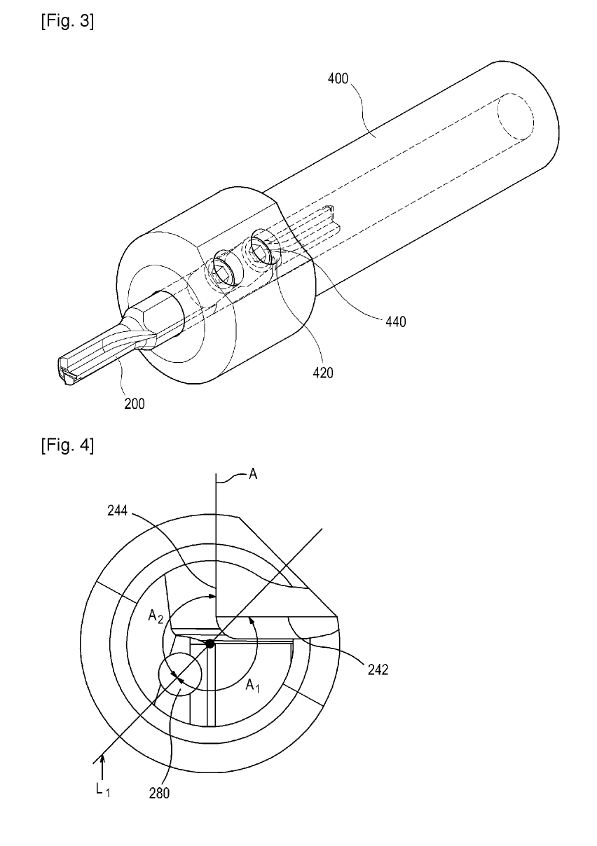

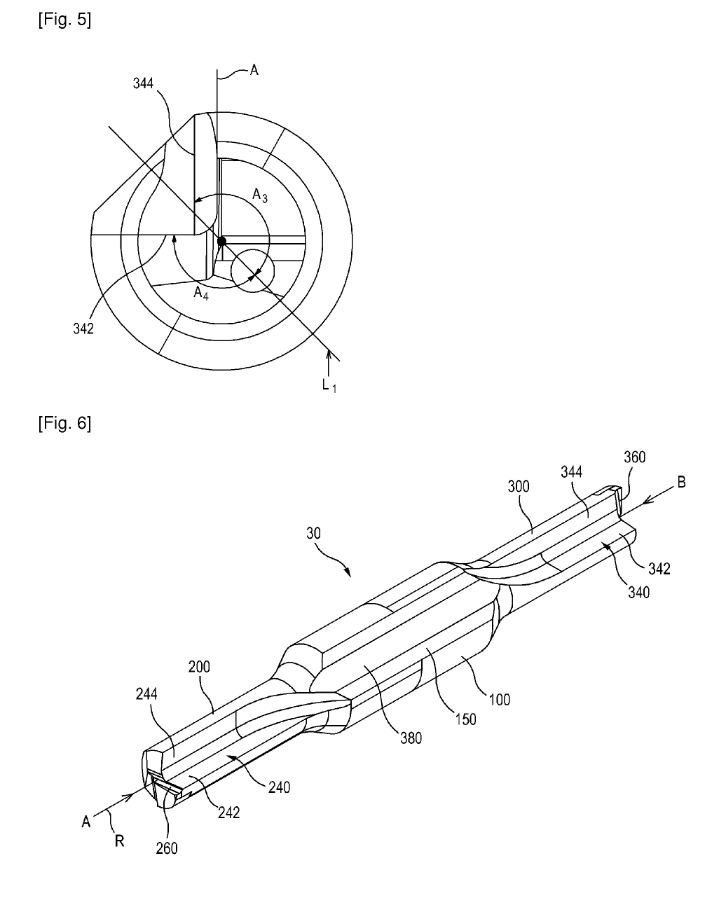

FIG. 2 is a schematic view of the multi-functional cutting tool in accordance with a first embodiment of the present invention. FIG. 3 is a perspective view of the multi-functional cutting tool fixed into a mounting sleeve in accordance with the present invention. FIG. 4 is a side view of the multi-functional cutting tool when viewed in Direction A of FIG. 2. FIG. 5 is a side view of the multi-functional cutting tool when viewed in Direction B of FIG. 2.

The multi-functional cutting tool (20) includes a shank (100), a first cutting portion (200) and a second cutting portion (300). The shank (100) is cylindrically shaped and has a flat surface (150) on its side. When the shank (100) is inserted into the inside of the mounting sleeve (400), the multi-functional cutting tool (20) is fixed so as not be rotated within the mounting sleeve (400) of the cutting device by pressurizing a flat surface (150) with a fixing member (440) inserted through a through hole (420) of the mounting sleeve (400).

The first cutting portion (200) and the second cutting portion (300), which extend from each end of the shank (100), are cylindrically shaped. A cooling hole (280) for cooling the cutting portions (200, 300) are formed to penetrate into the cutting tool (20) from one end to the other end of the cutting tool (20) in a direction of a rotational axis (R) of the cutting tool (20). The cooling hole (280) extends straight. When the cutting tool (20) works a work piece, cooling oil is provided from the rear of the mounting sleeve (400) where the multi-functional cutting tool (20) is inserted and is then supplied to the cutting portions (200, 300) through the cooling hole (280). The first cutting portion (200) and the second cutting portion (300) are provided with a first chip removing groove (240) and a second chip removing groove (340), respectively. Each chip removing groove (240, 340) straightly extends from the end of each cutting portion in the direction of a rotational axis (R) of the cutting tool. Preferably, to avoid any large torsion torque from being concentrated around the ends of the first and second chip removing grooves during a drilling operation, the first and second chip removing grooves (240, 340) are formed to be curved in the shape of a helix around the shank (100). Chips cut away during the drilling or boring operation can be discharged along the first chip removing groove (240) or the second chip removing groove (340).

The first chip removing groove (240) is formed by two planes extending in the direction of a rotational axis (R) of the cutting tool, i.e., by a first plane (242) and a second plane (244). Preferably, an inclination angle between the first plane (242) and the second plane (244) at the end of the first cutting portion (200) is approximately 90°. The second chip removing groove (340) is formed by two planes extending in the direction of a rotational axis (R) of the cutting tool, i.e., by a third plane (344) and a fourth plane (342). The third plane (344) is disposed on substantially the same plane as the second plane (244). The fourth plane (342) is disposed on substantially the same plane as the first plane (242). That is, the third plane (344) and the first plane (242) substantially perform the same function, while the fourth plane (342) and the second plane (244) perform the same function.

A first cutting edge (260) is provided with the first plane (242) at the end of the first cutting portion (200). A second cutting edge (360) is provided with the third plane (344) at the end of the second cutting portion (300). The first cutting edge (260) and the second cutting edge (360) are shaped so as to be capable of both drilling process and turning process. Their detailed shape may vary depending on the usage of the multi-functional cutting tool (20). Further, the first cutting edge (260) and the second cutting edge (360) can be integrally formed with the first cutting portion (200) and the second cutting portion (300), respectively. Also, they can be provided as a replaceable cutting insert type.

The shape and size of the first and second cutting portions (200, 300) and the first and second chip removing grooves (240, 340) are the same. Further, as shown in FIG. 4, in the first cutting portion (200), the first chip removing groove (240) is disposed at a position where the angle (A1) defined by the center of the cooling hole (280) and the first plane (242) and the angle (A2) defined by the cooling hole (280) and the second plane (244) are substantially the same. As described above, the cooling hole (280), the first plane (242) and the second plane (244) extend straight along the direction of a rotational axis (R) of the cutting tool. The fourth plane (342) and the third plane (344) are disposed on substantially the same plane as the first plane (242) and the second plane (244). Thus, as shown in FIG. 5, in the second cutting portion (300), the angle (A3) defined by the center of the cooling hole (280) and the third plane (344) and the angle (A4) defined by the center of the cooling hole (280) and the fourth plane (342) are substantially the same.

The flat surface (150) of the shank (100) is disposed to be almost perpendicular to an imaginary line (L1) bisecting the inclination angle of the first plane (242) and the second plane (244) in the first cutting portion (200) or the inclination angle of the third plane (344) and the fourth plane (342) in the second cutting portion (300).

Accordingly, even if the multi-functional cutting tool (20) is re-mounted such that the second cutting portion (300), which was inserted into the mounting sleeve (400), is mounted to protrude out of the mounting sleeve (400) for change of a cutting portion intended to be used, the position of the cutting edge (360) and the cooling hole (280) of the second cutting portion (300) would remain the same as that of the cutting edge (260) and the cooling hole (280) of the first cutting portion (200) when the first cutting portion protruded out of the mounting sleeve (400).

As such, regardless of which portion of the two cutting portions of the multi-functional cutting tool (20) is placed toward a work piece, the orientation of the cutting edges (260, 360) is not changed. Thus, working conditions do not have to be re-arranged in a turning process. Further, the first and second cutting edges (260, 360) of the first and second cutting portions (200, 300) generate heat by friction during the cutting process, which is to be cooled by cooling oil. Given that other cooling conditions (e.g., speed of cooling water, etc) are equal, the cooling effects of the first and second cutting portions (200, 300), particularly those of the first and second cutting edges (260, 360), are determined by the position of the cooling hole (280) with respect to the first and second cutting edges (260, 360). The cooling effects affect the lifespan of the first and second cutting portions (200, 300). In the present invention, since the cooling hole (280) and the cutting edges (260, 360) are disposed with the same arrangement in both first and second cutting portions (200, 300), the same cooling effects are provided with the first and second cutting portions (200, 300). Thus, the lifespan of the first cutting portion (200) and that of the second cutting portion (300) are substantially identical to each other. Further, since the cooling hole (280) is disposed at a position having the same arrangement with respect to both the first and second cutting edges (260, 360), the strength of the first and second cutting edges (260, 360) are the same.

Thus, the multi-functional cutting tool according to the first embodiment of the present invention is not only compatible with the turning and drilling processes, but it also expands the lifespan of the first and second cutting portions (200, 300) by providing the same cooling effects and the same strength.

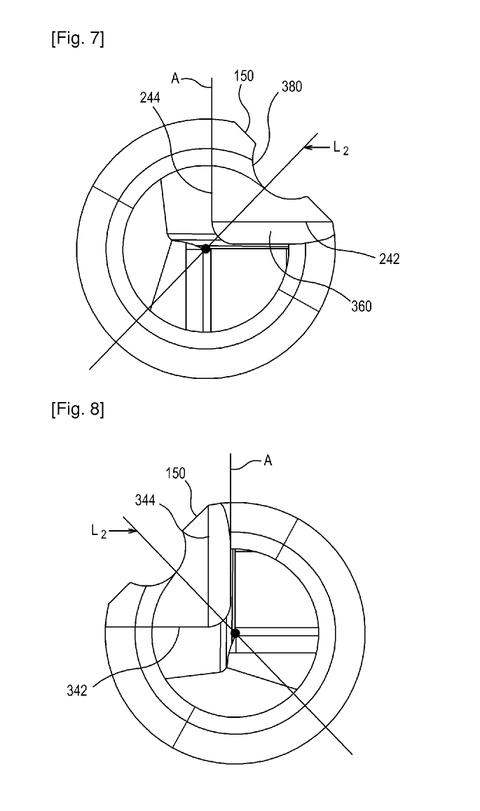

FIG. 6 is a schematic view of the cutting tool comprising a cooling groove in accordance with a second embodiment of the present invention. FIG. 7 is a side view of the multi-functional cutting tool when viewed in Direction A of FIG. 6. FIG. 8 is a side view of the multi-functional cutting tool when viewed in Direction B of FIG. 6. Except for the difference that a cooling groove is provided (instead of the cooling hole), the constitution of the second embodiment is identical to that of the first embodiment. Thus, the following description is focused on the constitution of the cooling groove.

As shown in FIG. 6, the cooling groove (380) extends straight in the direction of a rotational axis (R) of the multi-functional cutting tool (30). The cooling groove (380) is connected to a first chip removing groove (240) of a first cutting portion (200) and a second chip removing groove (340) of a second cutting portion (300). Thus, when the cutting tool (30) works a work piece, the cooling oil, which is provided from the rear of the mounting sleeve (400) where the multi-functional cutting tool (30) is inserted, flows from the second chip removing groove (340) of the second cutting portion (300), through the cooling groove (380), and to the first chip removing groove (240) of the first cutting portion (200). Thus, the multi-functional cutting tool (30) is cooled. As shown in FIGS. 7 and 8, a flat surface (150) of a shank (100) is disposed to be almost perpendicular to an imaginary line (L1) bisecting the inclination angle of a first plane (242) and a second plane (244) in the first cutting portion (200) or the inclination angle of a third plane (344) and a fourth plane (342) in the second cutting portion (300).

Accordingly, even if the multi-functional cutting tool (30) is re-mounted such that the second cutting portion (300), which was inserted into a mounting sleeve (400), is mounted to protrude out of the mounting sleeve (400) for change of a cutting portion intended to be used, the arrangement of the cooling groove (380) and the second cutting edge (360) of the second cutting portion (300) would remain the same as that of the first cutting edge (260) and the cooling groove (380) of the first cutting portion (200) when the first cutting portion (200) is protruded out of the mounting sleeve (400). Thus, similar to the first embodiment of the present invention, the multi-functional cutting tool according to the second embodiment of the present invention is not only compatible with the turning and drilling processes, but it also expands the lifespan of the first and second cutting portions (200, 300) by providing the same cooling effects and strength.

While the principles of the invention have been described herein, it is to be understood by those skilled in the art that this description is made only by way of example and not as a limitation as to the scope of the invention. Modifications and substitutions by one of ordinary skill in the art are considered to be within the scope of the present invention.

1. A multi-functional cutting tool, comprising:
a shank having a flat surface to be fixed to a cutting device;
first and second cutting portions having a cylindrical shape, each of the first and second cutting portions extending from the respective ends of the shank; and
a cooling hole extending straight and penetrating into the cutting tool from the end of the first cutting portion to the end of the second cutting portion in a direction of a rotational axis of the cutting tool,
wherein the first cutting portion includes a first chip removing groove comprising a first plane having a first cutting edge and a second plane inclined at an angle with respect to the first plane,
wherein the second cutting portion includes a second chip removing groove comprising a third plane having a second cutting edge and being substantially on the same plane as the second plane and a fourth plane being substantially on the same plane as the first plane,
wherein respective angles defined by a center of the cooling hole and each of the first to fourth planes are substantially the same, and
wherein the flat surface is arranged to be substantially perpendicular to an imaginary line bisecting the inclination angle between the first plane and the second plane of the first cutting portion.

2. A multi-functional cutting tool, comprising:
a shank having a flat surface to be fixed to a cutting device;
first and second cutting portions having a cylindrical shape, each of the first and second cutting portions extending from the respective ends of the shank; and
a cooling groove formed on the flat surface of the shank and extending in a direction of a rotational axis of the cutting tool,
wherein the first cutting portion includes a first chip removing groove comprising a first plane having a first cutting edge and a second plane inclined at an angle with respect to the first plane,
wherein the second cutting portion includes a second chip removing groove comprising a third plane having a second cutting edge and being substantially on the same plane as the second plane and a fourth plane being substantially on the same plane as the first plane,
wherein the cooling groove is connected to the first chip removing groove and the second chip removing groove, and
wherein the flat surface is arranged to be substantially perpendicular to an imaginary line bisecting the inclination angle between the first plane and the second plane of the first cutting portion.

3. The multi-functional cutting tool of claim 1, wherein the cutting edge is integrally formed with the cutting tool.

4. The multi-functional cutting tool of claim 1, wherein the cutting edge is formed at a cutting insert mountable on the cutting portions.

5. The multi-functional cutting tool of claim 1, wherein the first chip removing groove and the second chip removing groove are formed to be curved in the shape of a helix around the shank.

6. The multi-functional cutting tool of claim 2, wherein the cutting edge is integrally formed with the cutting tool.

7. The multi-functional cutting tool of claim 2, wherein the cutting edge is formed at a cutting insert mountable on the cutting portions.

8. The multi-functional cutting tool of claim 2, wherein the first chip removing groove and the second chip removing groove are formed to be curved in the shape of a helix around the shank.
